(19) United States
(12) Patent Application Publication
(10) Pub. No.: US 2003/0227625 A1
(43) Pub. Date: Dec. 11, 2003

(54) Wafer alignment device and method

(76) Inventors: Dave Alan Heisley, Tucson, AZ (US); Ravinthiran Balasingam, Tucson, AZ (US); Gregory Stewart Waterfall, Tucson, AZ (US); Russell Eugene Barcey, Tucson, AZ (US)

Correspondence Address: TEXAS INSTRUMENTS INCORPORATED, P O BOX 655474, M/S 3999, DALLAS, TX, 75265

(21) Appl. No.: 10/164,445

(22) Filed: Jun. 6, 2002

(51) Int. Cl. G01B 11/00

(52) U.S. Cl. 356/401

(57) ABSTRACT

An alignment target structure includes a reflective member and a non-reflective field proximate to the member. The field is configured to enhance identification of the target and/or to enhance contrast between the member and the field. The field may include an absorptive structure and/or a diffractive structure.

### FIELD OF THE INVENTION

The present invention generally relates to an alignment target system for use on semi-conductor wafers. More particularly, the present invention relates to an alignment target system for detecting and/or setting the position of wafers.

### BACKGROUND OF THE INVENTION

In the semiconductor industry, precision alignment is often used to perform high precision operations on wafers and/or microchips during various processing and assembly steps. Precision alignment in semiconductor processing facilitates making small and precise microelectronic devices. In one alignment method, a scanning device generates a laser beam to scan a target structure located on a wafer that is to be aligned. Generally, the target structure is configured to have metal portions and non-metal portions. The laser beam is reflected from the metal portions to a photo detector, but ideally, the laser beam is not reflected to the photo detector from the non-metal portion.

As the laser beam scans the target structure, a change in the intensity of the beam reflected to the photo detector may suitably indicate the boundary between the metal portion and the non-metal portion. Identification of this boundary may facilitate identification of a reference point on the wafer and alignment of the wafer. Thus it is desirable to have suitable contrast in the beam intensity reflected to the photo detector from the metal/non-metal portions.

However, this contrast is often lacking, making it difficult to identify target structures with precision. The contrast may be poor when the non-metal portion undesirably reflects a substantial amount of the laser beam back to the photo detector. This reflection from non-metalized areas may arise for a number of different reasons. For example, silicon crystal can be essentially transparent to a laser beam at some frequencies and the beam may go through the wafer and be reflected from the bottom of a metalized wafer, from a boundary layer in the wafer structure, and/or from objects below the wafer, such as a metal chuck holding the wafer. This reflection undesirably reduces the contrast and can hinder the identification of the target structure/reference point.

Additionally, typical target structures may generate false minimum signals at the boundaries between the two portions, thus increasing the difficulty of identifying a boundary edge in a detection process. False minimums may arise due to edge slopes between the metal and non-metal portions of the target. These edge slopes can cause the laser beam to reflect away from the photo detector.

As smaller features are created on microchips, precision alignment systems are increasingly important. Furthermore, as microelectronic devices become smaller, smaller targets may be used, thus increasing the need for improved contrast between reflective and non-reflective areas. In particular, a need exists for a target structure device that can produce an improved contrast between the reflective and non-reflective areas.

### SUMMARY OF THE INVENTION

In accordance with various aspects of the present invention, a field is configured to enhance identification of a target and/or to enhance contrast between a reflective member and the field. In accordance with various exemplary embodiments of the present invention, the field includes an absorptive material and/or a scattering structure.

### BRIEF DESCRIPTION OF THE DRAWINGS

A more complete understanding of the present invention may be derived by referring to the detailed description and claims when considered in connection with the Figures, where like reference numbers refer to similar elements throughout the Figures, and:

FIGS. 1-2 illustrate a target structure in accordance with an exemplary embodiment of the present invention;

FIG. 3 illustrates a side view of a target structure in accordance with exemplary embodiments of the present invention;

FIGS. 4-7 illustrate other exemplary target structures in accordance with exemplary embodiments of the present invention;

FIG. 8 illustrates a side view of a field in accordance with an exemplary embodiment of the present invention;

FIG. 9 is a graph of experimental data in accordance with an exemplary embodiment of the present invention;

FIGS. 10-13 illustrate exemplary side views of wafers incorporating target structures in accordance with exemplary embodiments of the present invention; and

FIG. 14 illustrates a side view of another field in accordance with an exemplary embodiment of the present invention.

### DETAILED DESCRIPTION OF EXEMPLARY EMBODIMENTS OF THE INVENTION

In accordance with various aspects of the present invention, a field is configured to enhance identification of a target and/or to enhance contrast between a reflective member and the field. In accordance with an exemplary embodiment of the present invention, an alignment target structure is configured to be scanned by a suitable beam. The alignment target structure includes a field proximate to a reflective member. In accordance with various aspects of the present invention, all or part of the field is configured to enhance identification of the target, to enhance contrast between the reflective member and the field and/or to enhance the identification of the boundary between the field and the reflective member. The enhanced identification facilitates, for example, precision alignment of any suitable object. For example, the object may include wafers, microchips, and/or the like.

Precision alignment of the object(s) may be facilitated through high contrast in the optical recognition between the field and the reflective member. In accordance with an aspect of the present invention, a high contrast between the intensity of the beam reflected from the member and the beam reflected from the field is created. For example, the field is configured to create this high reflectivity contrast. In accordance with an exemplary embodiment of the present invention, the field may be configured to absorb a portion of the beam. In another exemplary embodiment of the present invention, the field may be configured to scatter a portion of the beam.

The beam may be any suitable beam of radiation, such as a laser beam, infrared beam, visible light beam, or any other type of radiation. Furthermore, the beam may be the same laser beam used for “trimming” the microchips, i.e.; adjusting performance by evaporating circuit elements, but operated at a reduced power level. The laser beam may, for example, be four to eight microns wide; however, any width laser beam may be used.

The field may be configured in various ways to absorb the beam. In an exemplary embodiment of the present invention, the field may be configured, in whole or in part, with a beam absorptive material. An absorptive material causes the energy in the beam to be converted to a mechanical, thermal, or chemical form. Thus, an absorptive material consumes a portion of the beam and reduces the amount of the beam that can be reflected to the photo detector. In one example, the field may be configured with a polycrystalline absorptive material by growing the polycrystalline structure on the surface of a wafer. However, additional silicon crystal layers may exist above and below the polycrystalline structure. Methods of growing polycrystalline structures, etching, and other techniques are not described in detail herein.

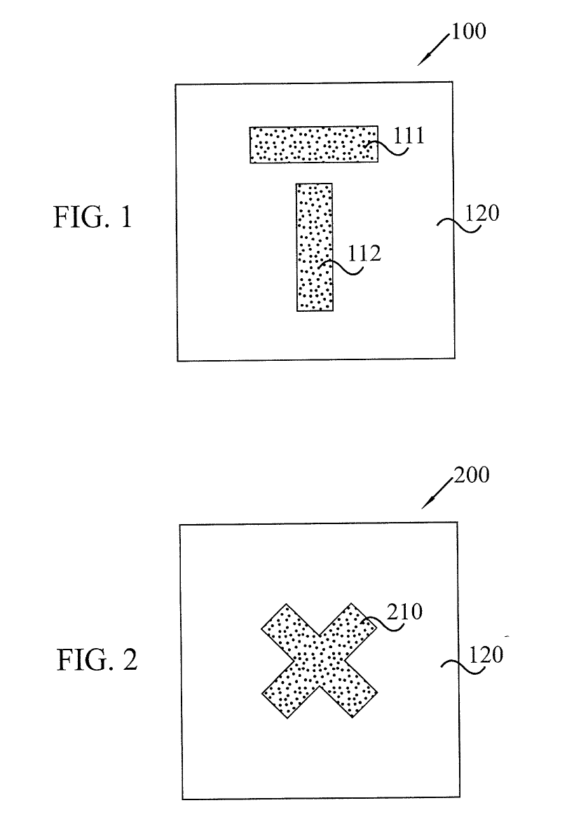

With reference now to FIG. 1, an exemplary target structure 100 includes a field 120 in proximity to a reflective member (e.g., 111 and 112). In this case, field 120 comprises an absorptive material that includes a layer of polycrystalline. Field 120 is configured proximate to any suitable reflective member. A reflective member may include any member that is configured to cause a beam to be directed to a photo-detector or similar device. Thus, a reflective member may cause the beam to be reflected approximately along its original incoming path to a photo-detector located at the source of the beam. However, the photo-detector could be located in a position removed from the source of the beam, and the reflective member may be configured to direct the beam to the photo-detector.

The reflective member may include any suitable number of reflective areas, for example, a first reflective member 111 and a second reflective member 112. Reflective members 111 and 112 may include any suitable shape, for example, rectangular. Furthermore, the member(s) may be configured with various orientations, patterns, or layouts to suitably identify a reference point. For example, two rectangular members may be oriented at right angles to each other. In this case, first member 111 represents a Y axis reference point and second member 112 represents an X axis reference point. Other coordinate systems may also be selected for suitably identifying a reference point. For example, and with momentary reference to FIG. 2, a target structure 200 is configured with a single member 210 configured in an X shape, and proximate to field 120.

In another exemplary embodiment of the present invention, the field may be configured to scatter all or a portion of the beam. Scattering the beam may include reflection of the beam at an angle (deflection) and/or refraction of the beam. Both processes cause the beam, or portions thereof, to be directed away from the photo detector. Scattering is facilitated, for example, by a field comprising at least one edge slope. The amount of scattering of the beam may depend on the angle of the edge slope(s) and/or the density of the edge slopes (i.e., boundaries per inch or boundaries per square inch), among other factors. The field may be configured with any suitable edge slope angle and density.

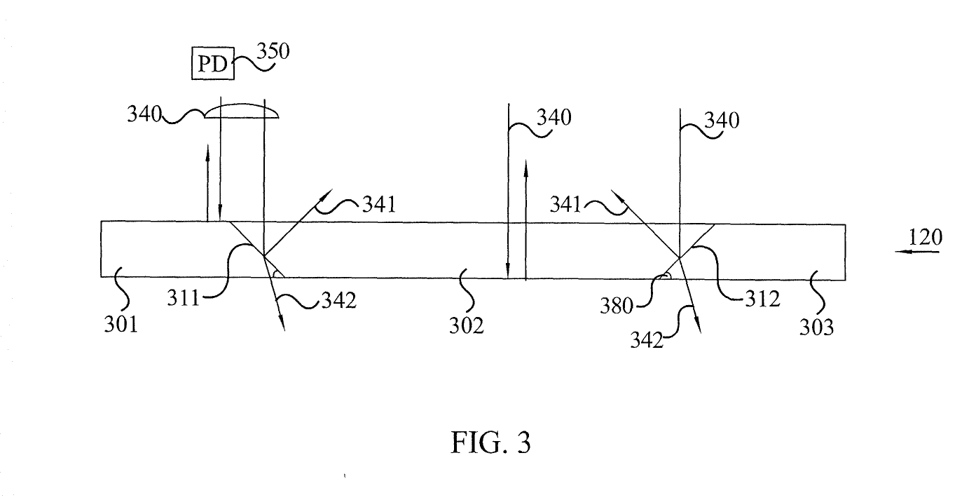

The field may be configured with edge slopes in various ways. For example, and with reference now to FIG. 3, field 320 may comprise a scattering structure where a first edge slope 311 may exist between a first material 301 and a second material 302 and a second edge slope 312 may exist between second material 302 and a third material 303. Edge slopes 311 and 312 may be at an angle 380 between 0 and 90 degrees from the surface of the wafer, for example 45 degrees. The edge slopes tend to cause a portion of the beam (e.g., 340) to be reflected (e.g., 341), or refracted (e.g., 342) away from a photo detector 350. Therefore, the field is configured with multiple edge slopes to scatter a portion of the beam incident on field 120.

In accordance with various aspects of the present invention, the field is configured to have multiple edge slopes. These edge slopes may be formed in a variety of other ways. For example, edge slopes may be formed by configuring field 120 with oxide cuts and/or contact type cuts. In another exemplary embodiment of the present invention, edge slopes may be formed by configuring at least two different materials adjacent to each other in field 120.

The different materials may suitably comprise any appropriate materials. For example, field 120 may include areas of poly-silicon adjacent to areas of substantially uniform crystalline structure. This poly/no-poly formation creates boundaries, and thus edge slopes between the poly/no-poly areas. Each edge slope may scatter the laser beam away from the photo detector. In another example, field 120 includes areas that have been diffused adjacent to areas of that are substantially not diffused, forming edge slopes between the areas of diffusion/non-diffusion. In other examples, edge slopes may also be created between areas of metal/non-metal, dielectric/non-dielectric, and/or the like.

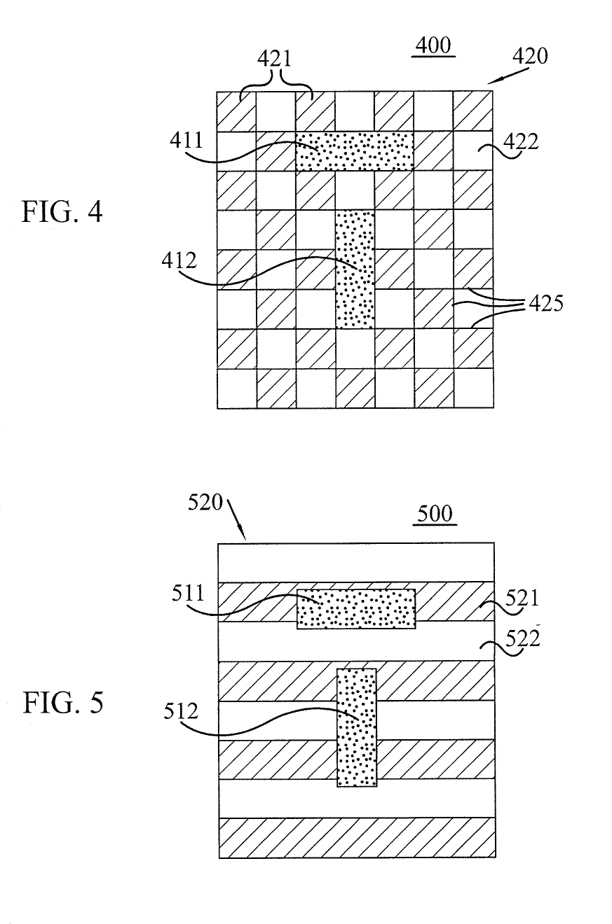

The edge slopes in field 120 may be formed in any suitable layout or pattern. In one exemplary embodiment of the present invention, and with reference to FIG. 4, target structure 400 comprises a field 420 including a grid layout of two types of material. In the grid layout, boundaries (e.g., 425) may exist between a first material 421 and a second material 422 in field 420. The boundaries 425 facilitate scattering of the beam, improving reflected beam contrast between the member (e.g., 411 and 412) and field 420, and target structure identification.

In a further exemplary embodiment of the present invention, the deflective edge-slope configuration may be combined with the polycrystalline absorptive embodiment discussed above. In this case, first material 421 includes polycrystalline and second material 422 includes a non-polycrystalline material. Thus, target structure 400 is configured with a checkerboard of (“poly/no-poly”) areas having edge slopes at the boundaries between the two types of areas.

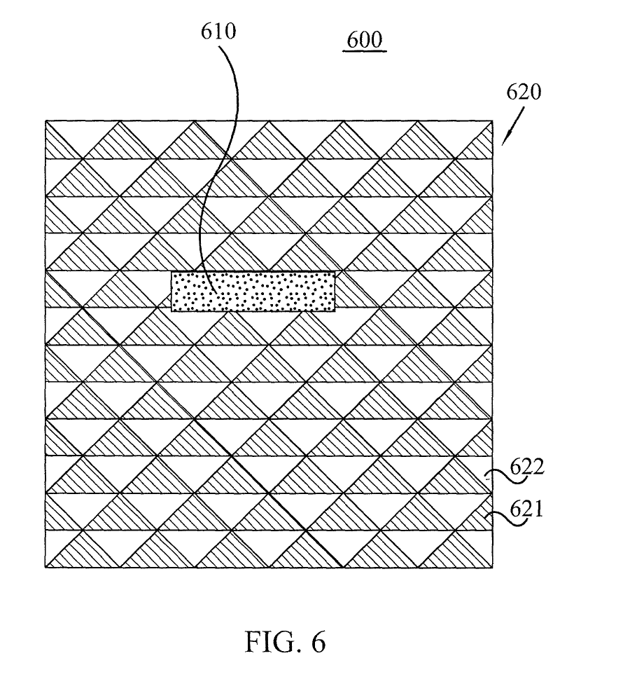

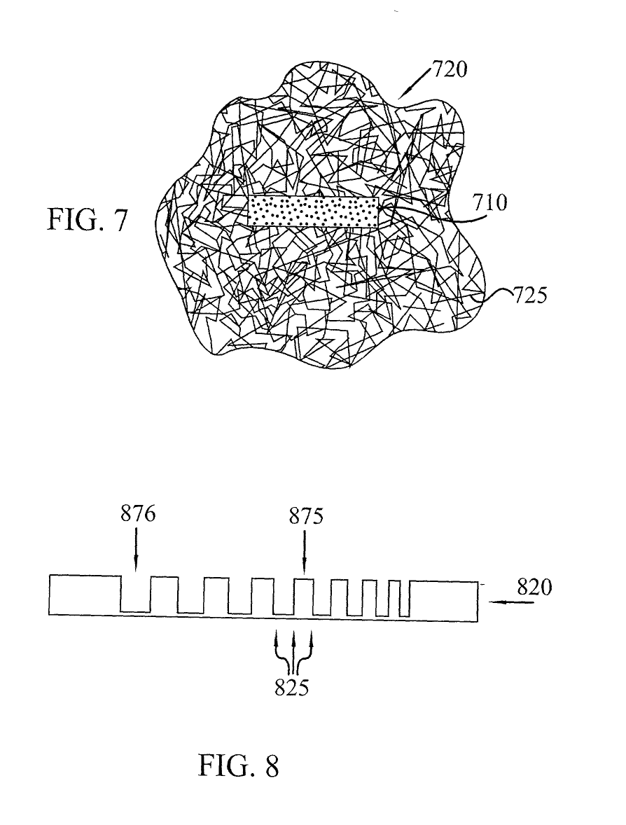

The edge slopes may, however, be laid out in other suitable configurations. With reference to FIG. 5, an exemplary target structure 500 is configured with a field 520 having a striped pattern of polycrystalline areas 521 and non-polycrystalline areas 522. The striped pattern may be suitably oriented at various angles. With reference to FIG. 6, another exemplary target structure 600 is configured with a field 620 having a triangular pattern of polycrystalline areas 621 and non-polycrystalline areas 622. Furthermore, and with reference to FIG. 7, target structure 700 may be configured with a field 720 having an abstract pattern of edges 725.

Although the edge slopes may be formed between the first and second areas comprising polycrystalline and non-polycrystalline, respectively, other materials may be used to form edge slopes and edge slopes may be formed in a single material as discussed herein. For example, and with reference to FIG. 8, edge slopes 825 may be formed by contact cuts 876 in the silicon field 820. Gradations in reflection may be achieved by varying the distance between the contact cuts 876 and the width of the posts 875 remaining after the cuts. Each cut may have two or more edge slopes. Furthermore, the field may be configured in any manner that creates areas of low reflectivity field areas in contrast with the high reflectivity member areas.

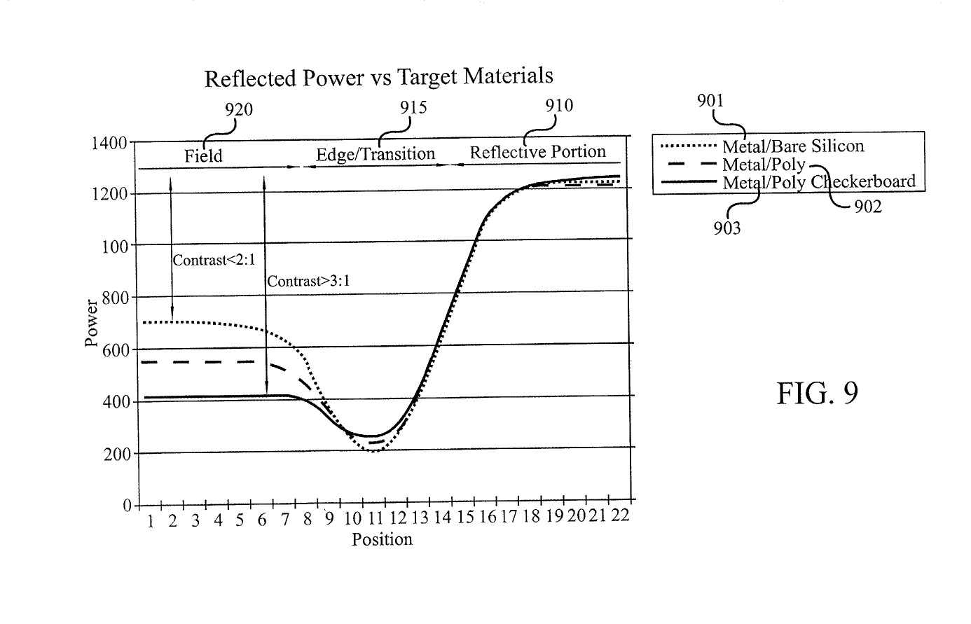

With reference now to FIG. 9, experimental data can be graphed to show an improvement in the contrast between the reflected power from the field and the member. The X axis represents scanable position in the target structure, with the section designated 920 being associated with the field, section 915 associated with the boundary between the member and the field, and section 910 associated with the member. In each experiment, a metal member portion was configured in proximity with a field. The Y axis represents the amount of power reflected from the target structure sections. Curve 901 indicates the reflected power from the different sections of the target structure when the field comprises bare silicon. Curves 902 and 903 indicate the reflected power from the different sections of the target structure having a field comprising a polycrystalline and a field comprising a poly/no-poly checkerboard, respectively.

The contrast in the field improves from the bare silicon field curve 901 to the poly crystalline curve 902 to the poly/no-poly checkerboard curve 903. At the same time, the false minimum, located at edge/transition 915, is improved with the polycrystalline curve 902 and poly/no-poly checkerboard curve 903. Thus, configuring field 120 with an absorptive material such as polycrystalline, and/or configuring the field with edge slopes, enhances identification of the target structure and thus enhances precision alignment of the wafer.

The target structure can be manufactured in any suitable manner. For example, the member(s) may be configured to reflect a relatively high percentage of the laser beam to the photo detector. Furthermore, the member(s) may be configured in various ways to reflect beams of various wave lengths. For example, the member may be configured to reflect infra red laser beams, visible radiation beams, and/or other light beams. Also, the member may be made of any reflective material. In various embodiments of the present invention, the member is made of a metal. For example, the metal may be aluminum, copper, or gold. The material may also be configured to have relatively smooth surfaces for high reflectivity. In exemplary embodiments of the present invention, the member may be created using various metal deposition techniques.

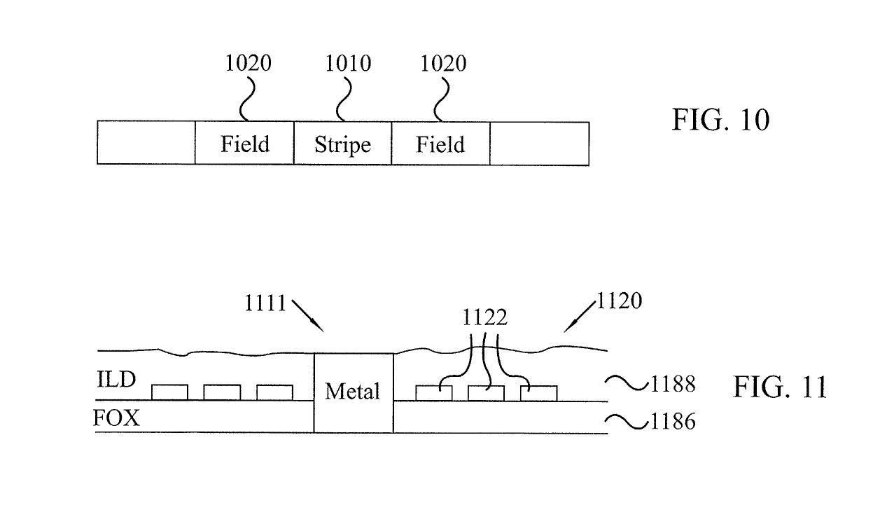

The field may be configured in proximity to the member in various ways. For example, and with momentary reference to FIG. 10, member 1010 may be located at substantially the same level as field 1020. FIG. 11 illustrates an exemplary side view of an exemplary semiconductor wafer. A wafer may comprise, for example, one or more field oxide layers 1186 with one or more interlayer dielectric layers 1188. Field 1120 may include more that one polycrystalline regions 1122 within, for example, the interlayer dielectric layer and in proximity to a member 1111.

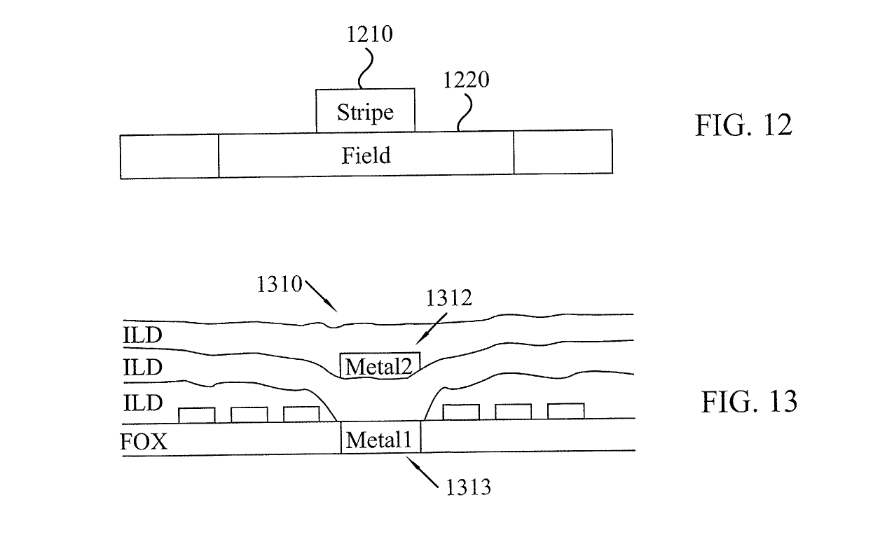

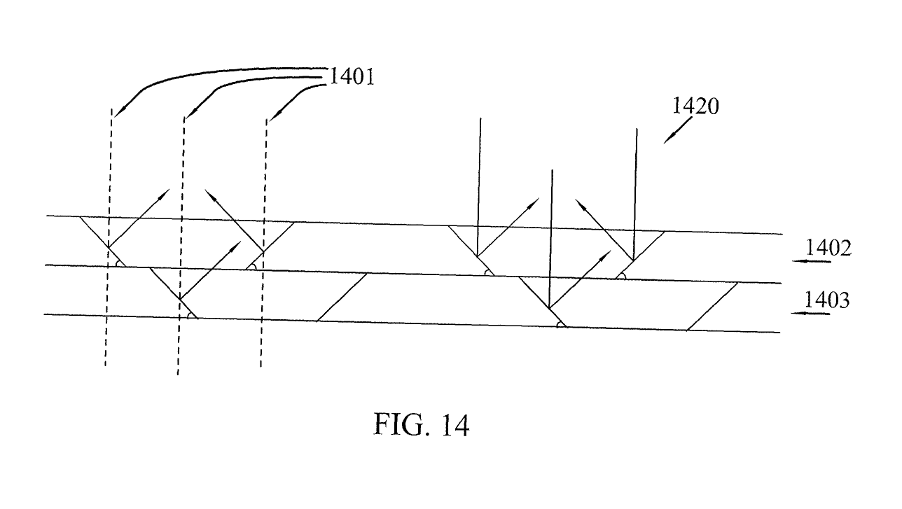

In accordance with another exemplary embodiment of the present invention, and with reference to FIG. 12, the field may be a continuous field 1220 with member 1211 super-imposed over field 1220. Furthermore, other member/field structures may be formed. For example, the member may comprise multiple layers of metal. In one example, FIG. 13 illustrates an exemplary side view of a wafer structure comprising a member 1310 including a first metal portion 1313 and a second metal portion 1312. In another example, and with reference to FIG. 14, edges 1401 may be created in various layers and may or may not be stacked to form a composite multi layer (e.g., 1402 and 1403) field 1420 of edges. Such a configuration may suitably be configured to increase the density of edge slopes per length or per area.

Various processes are not described in detail herein for creating edges in fields, for configuring a field with an absorptive material and for configuring the target structure with a member. However, etching, deposition, photo-lithography, and similar processes may be used. The alignment target structure can be suitably located on any aligned object. For example, the alignment target structure can be placed on a wafer. Furthermore, in other exemplary embodiments of the present invention, the alignment target structure can be placed on each die on a wafer. In addition, the alignment target structure can be used for any alignment application or any precision positioning of a chip, e.g., laser cutting, additional photo-lithography steps, dicing, packaging/assembly and/or the like.

The present invention has been described above with reference to various exemplary embodiments. However, those skilled in the art will recognize that changes and modifications may be made to the exemplary embodiments without departing from the scope of the present invention. For example, the various components may be implemented in alternate ways. These alternatives can be suitably selected depending upon the particular application or in consideration of any number of factors associated with the operation of the alignment system. In addition, the techniques described herein may be extended or modified for use with other types of devices, in addition to the target structures. For example, these techniques may be used to recognize a particular device and/or distinguish one device from another. These and other changes or modifications are intended to be included within the scope of the present invention.

What is claimed is:

1. An alignment target comprising:
a reflective member; and
a non-reflective field configured to be proximate to said reflective member and comprising an absorptive material and a scattering structure, wherein said absorptive material comprises a poly-crystalline material.

2. The alignment target of claim 1 wherein said scattering structure comprises at least one edge slope.

3. The alignment target of claim 2 wherein said at least one edge slope is formed by boundaries between areas of poly and no poly.

4. The alignment target of claim 3 wherein said edge slopes are created in a checkerboard pattern.

5. The alignment target of claim 4 wherein said reflective member comprises a metal.

6. The alignment target of claim 2 wherein said at least one edge slope is formed by contact cuts in a single material.

7. The alignment target of claim 2 wherein said edge slopes are formed by diffusion.

8. The alignment target of claim 2 wherein said edge slopes are formed on more than one layer.

9. The alignment target of claim 5 wherein said reflective member comprises two rectangular reflective members located at right angles to each other.

10. An alignment target comprising:
a reflective member; and
a non-reflective field configured to be proximate to said reflective member and comprising at least one of an absorptive material and a scattering structure.

11. The alignment target of claim 10, said non-reflective field comprising both said absorptive material and said scattering structure.

12. The alignment target of claim 10 wherein said absorptive material comprises a poly-crystalline material.

13. The alignment target of claim 10 wherein said scattering structure comprises at least one edge slope.

14. The alignment target of claim 13 wherein said at least one edge slope is formed by boundaries between areas of poly and no poly.

15. The alignment target of claim 14 wherein said edge slopes are created in a checkerboard pattern.

16. The alignment target of claim 15 wherein said member comprises a metal.

17. The alignment target of claim 13 wherein said at least one edge slope is formed by contact cuts in a single material.

18. A wafer alignment system comprising:
a photo-detector;
a wafer configured to be scanned by a beam from said photo-detector; wherein said wafer comprises an alignment target further comprising:
a reflective member; and
a non-reflective field configured to be proximate to said reflective member and comprising at least one of an absorptive material and a scattering structure, wherein said non-reflective field is configured to enhance contrast in the amount of said beam reflected to said photo-detector by said non-reflective field and said reflective member and thereby enhance wafer alignment.

19. The wafer alignment system of claim 18, said non-reflective field comprising both said absorptive material and said scattering structure.

20. The wafer alignment system of claim 18 wherein said absorptive material comprises a poly-crystalline material.

21. The wafer alignment system of claim 18 wherein said scattering structure comprises at least one edge slope.

22. The wafer alignment system of claim 21 wherein said at least one edge slope is formed by boundaries between areas of poly and no poly.

23. The wafer alignment system of claim 22 wherein said edge slopes are created in a checkerboard pattern.

24. The wafer alignment system of claim 23 wherein said member comprises a metal.

25. A method of aligning a wafer comprising the steps of:
shining a beam of light from a light source onto a wafer;
reflecting a portion of said beam of light from a reflective member to a photo-detector;
reflecting a reduced portion of said beam of light from a non-reflective field to said photo-detector, wherein said reflecting a reduced portion step comprises at least one of the steps of: absorbing a portion of said beam of light and reflecting a portion of said beam of light away from said photo-detector;
identifying a current position of said wafer based on the contrast in said beam of light reflected from said reflective member and said non-reflective field; and
adjusting the position of said wafer based on said current position of said wafer.

26. The method of claim 25, wherein said reflecting a reduced portion step comprises the steps of: absorbing a portion of said beam of light and reflecting a portion of said beam of light away from said photo-detector.

27. The method of claim 25 wherein said absorbing step is facilitated by a poly-crystalline material.

28. The method of claim 25 wherein said step of reflecting a portion of said beam of light away from said photo-detector includes scattering said beam of light with at least one edge slope.

29. The method of claim 28 wherein said at least one edge slope is formed by boundaries between areas of poly and no poly.

30. The method of claim 29 wherein said absorbing and said scattering are caused by edge slopes created in a checkerboard pattern with said poly and no poly areas.
